(19) United States
(12) Patent Application Publication
(10) Pub. No.: US 2023/0160463 A1
(43) Pub. Date: May 25, 2023

(54) CONE PULLEY ARRANGEMENT FOR A CONE PULLEY TRANSMISSION WITH NESTED COMPONENTS

(71) Applicant: Schaeffler Technologies AG & Co. KG, Herzogenaurach (DE)

(72) Inventors: Kornelius Wiegert, Achern (DE); Manuel Falk, Bühl (DE); Raphael Klima, Betschdorf (FR)

(73) Assignee: Schaeffler Technologies AG & Co. KG, Herzogenaurach (DE)

(21) Appl. No.: 16/979,010

(22) PCT Filed: Feb. 21, 2019
(86) PCT No.: PCT/DE2019/100168

§ 371 Date: Oct. 5, 2020

(30) Foreign Application Priority Data
Mar. 22, 2018 (DE) 102018106774.7

(51) Int. Cl. F16H 55/56; F16H 9/12

(52) U.S. Cl. CPC F16H 55/56; F16H 9/12

(57) ABSTRACT

A cone pulley arrangement (1) for a cone pulley transmission, comprising:
a shaft (2) which can be rotated about a rotational axis (3);
at least one bearing (4, 5) by means of which the shaft (2) can be mounted;
a first cone pulley (6), which is torsionally fixed and is fixedly connected to the shaft (2) in an axial direction (7);
a second cone pulley (8) which is fixedly connected to the shaft (2) and is adjustable in the axial direction (7) relative to the shaft (2);
a gearwheel (9) which is fixedly connected to the shaft (2); and
an actuating member (10) for adjusting the second cone pulley (8), comprising a spring (11) and a piston (12), wherein the spring (11) and the piston (12) are at least partially nested with the gearwheel (9) or with the at least one bearing (4, 5) in the axial direction (7).

The invention relates to a cone pulley arrangement for a cone pulley transmission, for example of the CVT (Continuously Variable Drive) type, preferably for a motor vehicle. In particular, the cone pulley transmission is used in conjunction with an internal combustion engine or other power unit to drive a motor vehicle.

Such a cone pulley transmission regularly comprises at least one first cone pulley arrangement in the manner of a first cone pulley pair and at least one second cone pulley arrangement in the manner of a second cone pulley pair, in each case with a first cone pulley displaceable in the axial direction and a second cone pulley fixed in the axial direction, as well as a belt means arranged for torque transmission between the cone pulley pairs. To pre-tension the belt means, a compression spring in the form of a helical spring is arranged between at least one of the first cone pulleys and an element which is fixed in the axial direction.

Such a cone pulley transmission with two cone pulley arrangements is known, for example, from DE 198 57 710 A1, to which reference is hereby made in full for the description of the two cone pulley arrangements or the cone pulley transmission. Disadvantages of the well-known cone pulley transmissions are their high installation space requirements and their high weight.

On this basis, the present invention is based on the task of at least partially overcoming the disadvantages known from the state of the art and of prescribing a cone pulley arrangement with which cone pulley transmissions can be manufactured with a smaller installation space requirement and lower weight.

This task is solved with a cone pulley arrangement according to the characteristics of the independent claim. Further preferred embodiments of the cone pulley arrangement are given in the dependent claims. It should be noted that the characteristics individually listed in the dependent claims can be combined with each other in any technologically useful way and define further characteristics of the invention. In addition, the characteristics indicated in the claims are further specified and explained in the description, and further preferred embodiments of the invention are presented.

A cone pulley arrangement for a cone pulley transmission contributes to this, and it comprises at least the following components:
a shaft that can be rotated around a rotational axis;
at least one bearing by means of which the shaft can be mounted;
a first cone pulley, which is torsionally fixed and is fixedly connected to the shaft in the axial direction;
a second cone pulley, which is fixedly connected to the shaft and adjustable in the axial direction relative to the shaft;
a gearwheel which is fixedly connected to the shaft; and
an actuating member for adjusting the second cone pulley, comprising a spring and a piston, wherein the spring and the piston are at least partially nested in the axial direction with the gearwheel or with the at least one bearing.

The cone pulley transmission can be a continuously variable transmission (CVT). The cone pulley transmission can be a variable speed transmission. The cone pulley transmission can be arranged in a drivetrain of a motor vehicle. The transmission ratio of the cone pulley transmission can be smoothly adjusted. The cone pulley transmission can have a first cone pulley pair in the form of a first cone pulley arrangement and a second cone pulley pair in the form of a second cone pulley arrangement. The first cone pulley arrangement and the second cone pulley arrangement can have parallel rotational axes.

Each cone pulley arrangement has a shaft that can be rotated about a rotational axis. The shaft can be mounted by at least one bearing, for example on a housing of the cone pulley transmission. At least one bearing can be a ball bearing, roller bearing or conical roller bearing. In particular, the cone pulley arrangement can have a first bearing to mount the shaft at a first longitudinal end and a second bearing to mount the shaft at a second longitudinal end.

The cone pulley arrangement has a first cone pulley which is fixedly connected to the shaft in the axial direction, i.e., in particular parallel to the rotational axis. The first cone pulley can thus be rotated with the shaft around the rotational axis, but cannot be adjusted in the axial direction relative to the shaft. The first cone pulley can be formed in one piece with the shaft. In addition, the cone pulley arrangement has a second cone pulley which is fixedly connected to the shaft and can be adjusted in the axial direction relative to the shaft. For this purpose, the shaft can have external gearing and the second cone pulley can have internal gearing which connect the shaft and the second cone pulley to each other. The second cone pulley can be rotated with the shaft around the rotational axis. The first cone pulley and the second cone pulley are arranged in the axial direction, in particular side by side, so that a belt means of the cone pulley transmission can be guided between the first cone pulley and the second cone pulley. The cone pulley arrangement can thus be driven by the belt means. In addition, the belt means can be driven by the cone pulley arrangement. The belt means can be a traction means. The belt means can be a chain. The chain can be a sprocket chain. The chain can have lugs and pressure pads. The pressure pads can be used to couple the belt means to the cone pulley pairs. The coupling between the pressure pads and the cone pulley pairs can be a frictional fit. The lugs can be used to couple the pressure pads. The belt means can assume a running position depending on a transmission ratio of the cone pulley transmission. The running position of the belt means can change with a change in the transmission ratio of the cone pulley transmission.

In addition, the cone pulley arrangement has a gearwheel which is fixedly connected to the shaft. In particular, the gearwheel has an external gearing. In particular, at least one input drive of the motor vehicle can be driven via the gearwheel. In addition, the cone pulley arrangement can be driven via the gearwheel.

The cone pulley arrangement has an actuating member for adjusting the second cone pulley. The adjustment of the second cone pulley is used in particular to change a transmission ratio of the cone pulley transmission. The actuating member consists of a spring, which is in particular designed in the manner of a helical spring. The spring is in particular pre-tensioned. The spring is in particular a compression spring. A first longitudinal end of the spring is supported in particular by the second cone pulley and a second longitudinal end of the spring is supported in particular by a piston of the actuating member. In particular, the piston is torsionally fixed and is fixedly connected to the shaft in the axial direction. The piston is thus rotatable with the shaft around the rotational axis. The piston can be a sheet metal component, in particular a deep-drawn one. The piston can also be cup-shaped. The spring allows the second cone pulley to be adjusted in the axial direction to the first cone pulley. The piston can form a pressure chamber with the second cone pulley, to which a pressure medium, for example a hydraulic oil, can be input. By means of the pressure medium, the second cone pulley can be adjusted in the axial direction, in particular against a spring force of the spring. The second cone pulley can have a tubular section which is guided on an outer peripheral surface of the piston when the second cone pulley is adjusted in the axial direction. The outer peripheral surface of the piston can have a receptacle, e.g., in the form of a groove, in which a seal, e.g., in the form of a toroidal sealing ring, lip seal or O-ring, can be located. This allows the pressure chamber to be sealed against the environment. With regard to the further design of the cone pulley arrangement or the cone pulley transmission, reference is made to the above DE 198 57 710 A1. The en-ergy storage described there corresponds to the spring mentioned here.

The spring and the piston are at least partially nested with the gearwheel or with the at least one bearing in the axial direction. This means in particular that the spring and the piston overlap at least partially with the gearwheel or at least one bearing in the axial direction. This allows the cone pulley arrangement to be particularly compact and therefore lightweight.

The spring and the piston can at least partially engage the gearwheel or at least one bearing.

The gearwheel can have an axial recess. This allows the spring and piston to engage in the axial recess of the gearwheel.

The at least one bearing can have an axial recess. This allows the spring and piston to engage in the axial recess of at least one bearing.

The axial recess can be formed in a bearing inner ring of at least one bearing.

The axial recess can be annular. This allows the axial recess to run 360° around the shaft.

The spring can engage in the axial recess with a first axial end.

The piston can engage in the recess with a second axial end.

The piston can be attached to the gearwheel or to at least one bearing. For this purpose, the piston in the area of a recess of the gearwheel or at least one bearing can have an outer diameter which (essentially) corresponds to an inner diameter of the recess.

The piston, the spring, the gearwheel and the at least one bearing can be arranged side by side on the shaft.

Both the invention and the technical environment will be explained in more detail below using the figures. It should be noted that the figure shows a particularly preferred variant of the invention, but is not limited thereto. In an exemplary and schematic manner:

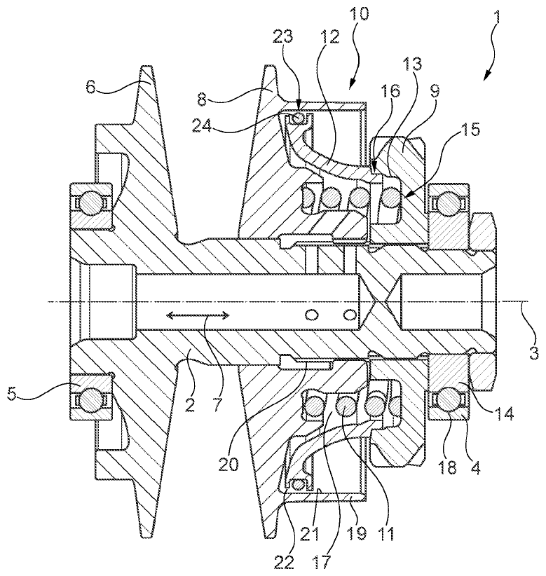

FIG. 1: shows a cone pulley arrangement in longitudinal section.

FIG. 1 shows a longitudinal section of a cone pulley arrangement 1. The cone pulley arrangement 1 has a shaft 2 which can be rotated about a rotational axis 3. The shaft 2 can be mounted with a first bearing 4 and a second bearing 5 on a housing of a cone pulley transmission, which is not shown here. The first bearing 4 and the second bearing 5 are designed like ball bearings. The first bearing 4 also has a bearing inner ring 14 and a bearing outer ring 18. A first cone pulley 6 is formed in one piece with shank 2. As a result, the first cone pulley 6 is torsionally fixed and is fixedly connected to the shaft 2 in the axial direction 7. The first cone pulley 6 can be rotated around the rotational axis 3 with the shaft 2. In addition, a second cone pulley 8 is fixedly connected to shaft 2 via a left-hand gearing 20. The second cone pulley 8 can thus be rotated with shaft 2 about the rotational axis 3. In addition, the second cone pulley 8 can be adjusted in the axial direction 7 relative to shaft 2. To adjust the second cone pulley 8, cone pulley assembly 1 has an actuating member 10 consisting of a spring 11 and a piston 12. The spring 11 is a helical spring with one longitudinal end supported by the second cone pulley 8 and an opposite longitudinal end supported by a gearwheel 9. The gearwheel 9 is torsionally fixed and is fixedly connected to shaft 2 in the axial direction 7. The spring 11 is pre-tensioned so that it presses the second cone pulley 8 against the first cone pulley 6 in the axial direction 7. This allows the second cone pulley 8 to be adjusted by spring 11 in the axial direction 7 in the direction of the first cone pulley 6. When the second cone pulley 8 is adjusted, a tubular section 19 of the second cone pulley 8 with an inner peripheral surface 21 slides along a radially outer peripheral surface 22 of the piston 12. On the outer peripheral surface 22, piston 12 has a circumferential groove 23 in which a seal 24 in the form of a sealing ring is arranged. The seal 24 seals a pressure chamber 17 for a pressure medium against an environment. The pressure medium allows the second cone pulley 8 to be moved away from the first cone pulley 6 in the radial direction 7 against the spring force of the spring 11, so that a distance between the first cone pulley 6 and the second cone pulley 8 increases. The gearwheel 9 has an annular recess 13 in which the spring 11 engages with the first axial end 15 thereof and the piston 12 with the second axial end 16 thereof, thus nesting with gearwheel 9. The piston 12 is also fixed with the second axial end 16 thereof to the recess 13 of gearwheel 9. In an alternative embodiment, the position of the gearwheel 9 and the first bearing 4 can be exchanged and the recess 13 can be formed in the bearing inner ring 14 of the first bearing 4.

The present invention makes a cone pulley arrangement for a cone pulley transmission particularly compact and easy to design.

### LIST OF REFERENCE SYMBOLS

1 Cone pulley arrangement
2 Shaft
3 Rotational axis
4 First bearing
5 Second bearing
6 First cone pulley
7 Axial direction
8 Second cone pulley
9 Gearwheel
10 Actuating member
11 Spring
12 Piston
13 Recess
14 Bearing inner ring
15 First axial end
16 Second axial end
17 Pressure chamber
18 Bearing outer ring
19 Tubular section
20 Longitudinal gearing
21 Internal periphery
22 External periphery
23 Groove
24 Seal

1. A cone pulley arrangement (1) for a cone pulley transmission, comprising:
a shaft (2) which can be rotated about a rotational axis (3);
at least one bearing (4, 5) by means of which the shaft (2) can be mounted;
a first cone pulley (6), which is torsionally fixed and is fixedly connected to the shaft (2) in an axial direction (7);
a second cone pulley (8) which is fixedly connected to the shaft (2) and is adjustable in the axial direction (7) relative to the shaft (2);
a gearwheel (9) which is fixedly connected to the shaft (2); and
an actuating member (10) for adjusting the second cone pulley (8), comprising a spring (11) and a piston (12), wherein the spring (11) and the piston (12) are at least partially nested with the gearwheel (9) or with the at least one bearing (4, 5) in the axial direction (7).

2. The cone pulley arrangement (1) according to claim 1, wherein the spring (11) and the piston (12) at least partially engage the gearwheel (9) or the at least one bearing (4, 5).

3. The cone pulley arrangement (1) according to one of the above claims, wherein the gearwheel (9) has an axial recess (13).

4. The cone pulley arrangement (1) according to one of the above claims, wherein the at least one bearing (4, 5) has an axial recess (13).

5. The cone pulley arrangement (1) according to claim 4, wherein the axial recess (13) is formed in a bearing internal ring (14) of the at least one bearing (4, 5).

6. The cone pulley arrangement (1) according to any one of claims 3 through 5, wherein the axial recess (13) is annular.

7. The cone pulley arrangement (1) according to one of claims 3 through 6, wherein the spring (11) engages with a first axial end (15) in the axial recess (13).

8. The cone pulley arrangement (1) according to one of claims 3 through 7, wherein the piston (12) engages with a second axial end (16) in the recess (13).

9. The cone pulley arrangement (1) according to any of the above claims, wherein the piston (12) is attached to the gearwheel (9) or to the at least one bearing (4, 5).

10. The cone pulley arrangement (1) according to one of the above claims, wherein the piston (12), the spring (11), the gearwheel (9) and the at least one bearing (4, 5) are arranged side by side on the shaft (2).
